(19) United States
(12) Patent Application Publication
(10) Pub. No.: US 2006/0190579 A1
(43) Pub. Date: Aug. 24, 2006

(54) Assisted command script template creation

(75) Inventors: Margaret Rachniowski, Nepean (CA); Craig Ellirt Timmerman, Stittsville (CA); Afshan Zabihi, Kanata (CA)

Correspondence Address: KRAMER & AMADO, P.C., Suite 240, 1725 Duke Street, Alexandria, VA, 22314, US

(73) Assignee: ALCATEL, Paris (FR)

(21) Appl. No.: 11/062,566

(22) Filed: Feb. 23, 2005

(51) Int. Cl. G06F 15/173

(52) U.S. Cl. 709/223

(57) ABSTRACT

A CLI command script template management system, tool, and human machine interface for script-based configuration management, service provisioning, operations and maintenance is provided. The system includes a CLI command dictionary repository, and means for loading a CLI command dictionary at run-time. Methods provide for obtaining a CLI command specification compatible with the CLI command set version currently deployed on the managed entity. The managed entity's help functionality is invoked and the output is captured and parsed to discover the CLI commands set currently deployed on the managed entity. Advantages are derived from enabling operations management personnel to create CLI script templates easily for any active managed entity deployed in a managed communications network, based on the vendor and model specific network node CLI command set software release currently installed thereon.

### FIELD OF THE INVENTION

The invention relates to network management and service provisioning in a communications network management context, and in particular to Command Line Interface (CLI) script-based configuration management, service provisioning, operations and maintenance.

### BACKGROUND OF THE INVENTION

In the field of communications network provisioning, Network Management Systems (NMS), such as the Alcatel 5620 NMS, employ Command Line Interface (CLI) scripts to inspect, configure, operate, and monitor managed active communications network entities deployed in a domain of control of a managed communications network infrastructure.

Managed entities deployed in a typical communications network, such as, but not limited to: physical switching nodes, aggregation nodes, deaggregation nodes, interface cards, statistics collectors, routers, bridges, switches, links, etc.; and logical virtual routers, paths, etc. are of multiple types, have multiple versions, and are developed by multiple vendors which update managed entity software in accordance with a variety of schedules, schedules which are not under the control of network operators.

Writing CLI scripts is often difficult because, at any given time, CLI command sets tend to vary across communications network equipment vendors, managed entity model types, software releases, and even across managed entities deployed in a managed communications network. This CLI command diversity presents a problem to network operators, as operations management personnel require special training to effectively mitigate such disparities, and the diversity makes acquiring the expertise to write scripts quickly and flawlessly for the various managed entities deployed in a communications network a challenging, time-consuming, and therefore costly task.

One solution for network operators has been to accept the challenge and send operations management personnel to attend vendors' training courses (e.g. Cisco certification courses), in a never ending cycle, in order to keep operations management personnel up-to-date with software changes. The cost of training courses may, to some extent, be mitigated by allotting time for operations management personnel to internalize voluminous amounts of software release notes whenever software upgrades are deployed. These costly and time-consuming approaches require ongoing such efforts.

In co-pending commonly assigned U.S. patent application Ser. No. 10/726,532, filed on Dec. 4^{th}, 2003, entitled “Method of Configuring Managed Entities in a Communications Network using Configuration Templates”, Bolder et al. describe methods of configuring multiple similar managed entities deployed in a communications network via CLI configuration script templates.

Bolder et al. realize that despite large amounts of resources being expended in training operations management personnel to gain experience with CLI command sets, human error is a further factor which cannot be ignored particularly when it comes to configuring managed network entities operating at high capacities. Bolder et al. provide a framework which enable highly trained analysis, versed in writing CLI scripts, to write parameterized vendor specific, equipment type specific, and software version specific CLI script templates for the variety of network equipment employed in a managed communication network. Operations management personnel derive CLI scripts from CLI script templates by querying a network management repository for target managed entity parameter values; the derived CLI scripts being sent to target managed entities for execution.

While use of the framework reduces the costly and time consuming efforts by training only a relatively small number of analysts, as a relatively large number operators are enabled to perform operations management tasks; the necessary human involvement remains a factor. In particular the resulting CLI scripts are as good as the analyst's proficiency with the most up-to-date CLI command sets deployed, subject to compatibility of the CLI command set versions of the CLI commands used in writing CLI script templates with the software versions currently installed on respective target deployed network equipment.

The compatibility of each CLI script template with the software version installed is brought into question with each software upgrade performed on the corresponding managed entities. It is the analyst's task to validate prior CLI command set version CLI script templates for use with the upgraded CLI command set version - a reasonable task which can be performed only if the analyst's training is up-to-date.

Prior art United States Patent Application publication number 2003/0135508 entitled “Translating Configuration Files Among Network Devices” published on Jul. 17^{th}, 2003 by Chorafakis et al. describes translating CLI scripts written in one CLI command set for a vendor equipment type, to an equivalent script written in another CLI command set for another vendor equipment type. However, it is apparent that the success of the Chorafakis et al. proposal is dependent on correct interpretation of CLI scripts and the extent to which a given CLI script is expressible internally by the Chorafakis et al. translator. In essence the proposed CLI script translator introduces complexities related to the scripting language used internally by the CLI script translator internally, internal scripting language which has to be updated with each new or changed CLI configurable aspect.

A related development in the art of specialized file editing, includes file type specific editors which provide automatic keyword completion (no syntax), thereby eliminating the need for the user to know the correct spelling of each and every keyword. Great benefits may be derived from using such specialized editors in coding software wherein the keywords are coding language tokens. The main drawback in using specialized editors is that such editors must be coded with all the coding language tokens and the user must at least know a unique first portion of the coding language tokens themselves. Special editors may be coded for software coding support as software coding languages typically have a self consistent coding set, which once developed changes very little. In accordance with such prior art efforts, in order to apply such techniques to CLI script template creation and maintenance, special purpose editors coded with each vendor equipment type software upgraded CLI command set have to be provided. It would be a tall order for all vendors to comply in a timely fashion with a requirement to provide a specialized editor with each CLI command set upgrade.

It is recognized that most operating system command shells and most command driven application, have built-in help functionality, which allows an operator to obtain command usage information regarding a shell's command set, including command syntax information. For example, often the entry of a ‘?’ at the command prompt is supported to access help information. For example typing: “?”, “show ?”, or “show <context>?”, is equivalent to asking the shell: “what can I do now”, “show me all valid commands I can enter”, or “show me all commands I can enter in respect of <a specific context>”. Although such functionality is beneficial, in the context network management and service provisioning, having an NMS system hardcoded with up-to-date CLI command sets of all multi-vendor equipment for all equipment types and for all software versions installed on all deployed equipment has, so far, proved to be an impossible task, the success of which depends entirely on the cooperation multiple vendor with the NMS software provider.

There therefore is a need to address the above mentioned issues related to deployed managed entity software version upgrades which requires keeping analysts up-to-date with CLI command set diversity and changes.

### SUMMARY OF THE INVENTION

In accordance with an aspect of the invention, a method of retrieving, in a network management and service provisioning context, a Command Line Interface (CLI) command set currently employed by a managed entity deployed in a managed communications network is provided. The method includes: accessing the managed entity, invoking help functionality on the managed entity, capturing output generated by the managed entity in response to the invocation of the help functionality, parsing the captured output, and updating a CLI command dictionary based on the captured output.

In accordance with another aspect of the invention, a method of auto-completing a CLI command, in a network management and service provisioning context, based on a Command Line Interface (CLI) command set currently employed by target managed entity deployed in a managed communications network is provided. The method includes: specifying the CLI command set version associated with the target managed entity, optionally specifying at least one first character of a CLI command name, invoking a command completion hot key, querying a run-time loaded CLI command dictionary, and providing a command completion options.

In accordance with a further aspect of the invention, a method for validating one of a Command Line Interface (CLI) script and a CLI script template for execution on a target managed entity deployed in a managed communications network is provided. The method includes a sequence of steps. The CLI command set version of the CLI command set currently deployed on the target managed entity is obtained. If the CLI command set version of the CLI command set currently deployed on the target managed entity matches the CLI command set version specified in respect of the one of the CLI script and the CLI script template, a run-time loaded CLI command ser version specific CLI command dictionary is queried based on CLI command tokens specified in the one of the CLI script and the CLI script template. And, CLI command token discrepancies between the CLI command token sequence specified in the one of the CLI script and the CLI script template, and the CLI command dictionary are selectively highlighted.

In accordance with a further aspect of the invention, a Command Line Interface (CLI) script template management system is provided. A network management repository holds managed entity information for a managed entity deployed in a managed communications network. A network management system for accessing the managed entity, the network management system further includes: messaging means for exchanging messages with the managed entity, means for capturing managed entity output from received messages, and a parser determining the CLI command set version from a message issued by the managed entity signifying a successful login. The parser updates a CLI command set version specific CLI command dictionary held in the network management repository based on CLI command set specifications obtained from the managed entity output captured. And, a CLI script template management tool operable in the network management and serviced provisioning context facilitated by the network management system to provide command completion in editing a CLI script template based on the CLI command set currently employed by the managed entity.

In accordance with yet another aspect of the invention, a Command Line Interface (CLI) command script template management tool for use in a centralized network management and service provisioning context is provided. The CLI command script template management tool includes: a user-interface for specifying a vendor specific, equipment type specific, CLI command set version; means for receiving user input in writing a CLI script template; means for loading a vendor specific, equipment type specific, CLI command set version CLI command dictionary at run-time; and a command completion hot key optionally responsive to at least one typed character to query the run-time loaded CLI command dictionary for command completion options.

Advantages are derived from enabling operations management personnel to create CLI script templates easily for any active managed entity deployed in a managed communications network, based on the vendor and model specific network node CLI command set software release currently installed thereon.

### BRIEF DESCRIPTION OF THE DRAWINGS

The features and advantages of the invention will become more apparent from the following detailed description of the exemplary embodiments with reference to the attached diagrams wherein:

FIG. 1 is a schematic diagram showing, in accordance with an exemplary embodiment of the invention, an interaction between a Network Management System and a managed entity, the interaction effecting CLI command auto-discovery;

FIG. 2 is a schematic diagram showing, in accordance with the exemplary embodiment of the invention, a CLI script template management tool interface and process steps enabling an analyst manage a CLI script template based on an up-to-date deployed CLI command set;

FIG. 3 is a schematic diagram showing, in accordance with the exemplary embodiment of the invention, successive invocation of command completion functionality with respect to the CLI script template management tool in a CLI script template management context; and

FIG. 4 is a flow diagram showing, in accordance with the exemplary embodiment of the invention, process steps validating a CLI script or a CLI script template for use on a target managed entity.

It will be noted that in the attached diagrams like features bear similar labels.

### DETAILED DESCRIPTION OF THE EMBODIMENTS

As mentioned herein above, considering the diversity of managed entities deployed in a typical managed communications network, it would be a tall order to expect CLI command set specifications to be provided by all equipment vendors in a timely fashion in respect of every deployed software upgrade. Even if all equipment vendors complied, it would also be a tall order for network management solution providers to timely deploy script editor updates with each equipment vendor update.

Typically each deployed physical managed entity provides a command driven management interface, via which, an operator logged in at the managed entity, can interact with the managed entity via CLI commands.

In accordance with the exemplary embodiment of the invention a CLI script template management tool is provided for assisting analysts in CLI script template creation, CLI script template validation, CLI script template editing, and CLI script template migration to a new CLI command set version deployed on the same vendor specific managed entity type, for deployed communications network equipment. In particular, the CLI script template management tool provides command completion functionality.

In accordance with the exemplary embodiment of the invention, a flexible CLI script template editor is provided, which is adapted to load, at run-time, a vendor specific, equipment type specific, software version specific CLI command set in order to provide token name completion and command completion in editing CLI script templates.

In accordance with the exemplary embodiment of the invention, in the absence of the provision of CLI command set specifications, CLI command set auto-discovery means are provided for obtaining at least a CLI command subset specification from active physical managed entities deployed in a managed communications network.

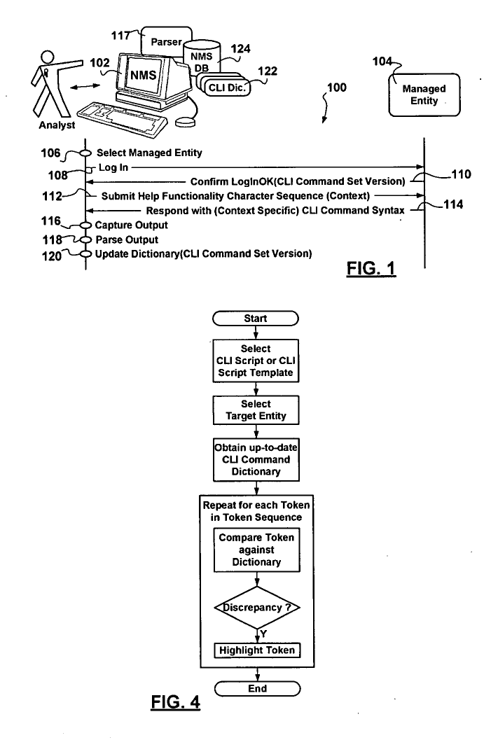

In accordance with an exemplary implementation of the exemplary embodiment of the invention shown in FIG. 1, CLI command auto-discovery is provided in a network management and service provisioning context from an NMS 102, the NMS 102 executing a CLI command auto-discovery process 100 in accordance with which a selected 106 target active physical managed entity 104 deployed in a managed communications network is accessed via the command line interface thereof by logging into 108 the managed entity 104, submitting 112 a character sequence to activate the help functionality, capturing 116 the output 114, and parsing 118 the output 114. A vendor-specific, equipment type specific, and software version specific CLI command dictionary 122 is updated 120 with the CLI command set specification parsed 118.

While CLI command specification auto-discovery functionality, including steps 112 to 120, is very desirable, the fact that it is obtained from active physical managed entities 114 deployed in a managed communications network raises issues regarding the efficient operation of the deployed managed entities queried for CLI command specifications as the queried managed entity has to expend processing cycles which are sacrificed from the intended operation of the active managed entity. Therefore, it is not efficient for operations management personnel to obtain usage information on a large number of CLI commands via CLI command specification auto-discovery 100. Without limiting the invention, it is undesirable for CLI command specification auto-discovery 100 to be performed in CLI script writing.

In accordance with the exemplary embodiment of the invention, CLI command set auto-discovery 100 is invoked from time-to-time by an analyst, in an administrative context, to update CLI command dictionaries 122 centrally maintained in a network management repository 124 by repeating steps 112 to 120.

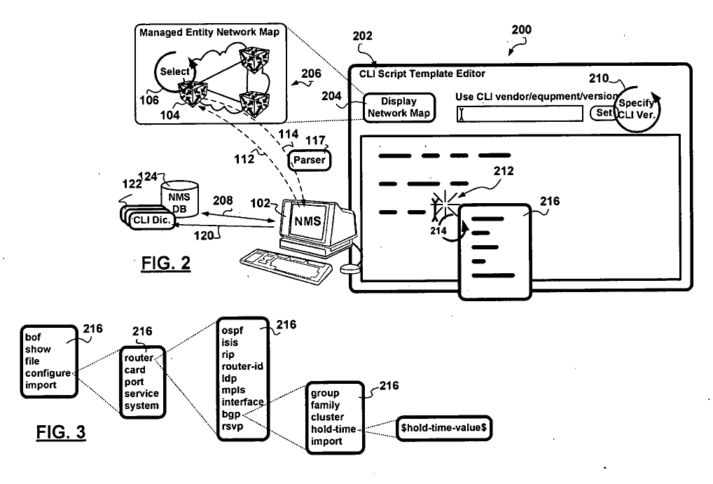

CLI command completion is provided via an exemplary CLI script template management tool (editor) 200, having an interface 202 shown in FIG. 2, from CLI command specifications held in vendor specific, equipment type specific, software version specific CLI command dictionaries 122.

Accordingly, an analyst interacts with the CLI command set auto-discovery interface 202, typically, but not necessarily, accessible via the CLI script template management tool 200, in a network management and service provisioning context. In particular the analyst interacts with a network map 206, typically accessible via interaction with a “display network map” button 204, to select 106 a target active physical managed entity 104 deployed in a managed communications network. Having selected 106 the target physical managed entity 104, in performing CLI command set auto-discovery 100, the NMS 102: queries 208 the network management repository 124 for login information, and logs into 108 the target physical managed entity 104. A parser 117 is activated and the login output 110 is captured 116. The output 110 indicating successful login, typically provides a specification of the active software version currently being used on the target managed entity 104. The NMS 102 queries 208 the network management repository 124 in the context of the target managed entity 104 to retrieve a character sequence necessary to invoke help functionality via the command line interface of the target managed entity 104, and issues the character sequence 112. As mentioned above the output 114 of the help functionality is captured 116.

In accordance with the exemplary embodiment of the invention, the help functionality output 114 is captured 116 by the parser 117. The parser 117 begins by extracting CLI command names and configuration context specifiers from the output 114 of the fist invocation 112 of the help functionality. The NMS 102 then, recursively invokes 112 the help functionality in respect of each command name and configuration context specifier while capturing 116 and parsing 118 the output 114, thereby successively discovering the hierarchy of the CLI command set. The entire CLI command set specification, including command syntax, is obtained via successive capture 116 and parsing 118 of the output 114 in accordance with the contextual recursive invocation 112 of the help functionality.

In accordance with an exemplary use scenario, at the beginning of a CLI script template creation session, the analyst specifies a CLI command set to be used by entering 210 vendor specific, equipment type specific, software versions specific information. The CLI script template management tool 200 invokes NMS 102 functionality to query 208 the network management repository 124 to retrieve 208 the corresponding CLI command dictionary 122. If a CLI command dictionary 122 having the vendor specific, equipment type specific, software version specific dictionary exists then the CLI command dictionary 122 is retrieved form the network management repository 124. If the vendor specific, equipment type specific, software version specific dictionary 122 does not exist in the network management repository 124, the network management repository 124 is queried 208 for an active vendor specific, equipment type specific managed entity 104 deployed in the managed communications network executing the specified software version. Having identified a target active managed entity 104, the NMS 102 proceeds with the CLI command set auto-discovery 100 as described above.

If the analyst does not know the CLI command set software version currently deployed on a target managed entity, the analyst need only log in on the target managed entity 108 to obtain the current CLI command set version from the login confirmation output 110.

In accordance with anther exemplary implementation of the exemplary embodiment of the invention, the analyst may specify a context for CLI command subset auto-discovery 100 on an as-needed, or as-requested, basis.

In accordance with another exemplary use scenario, if the analyst requires to create a CLI script template concerning VPN services, the VPN context can be indicated (210) at the beginning of the CLI script template creation session, or during the session, as needed. CLI command subset auto-discovery functionality 100 is invoked 204/210 in a VPN configuration context. Invoking CLI command subset auto-discovery functionality 100 on an as-needed basis provides a trade-off between bulk auto-discovery 100 of the entire CLI command set, which could be time-consuming, and per-command auto-discovery 100, which could also be time-consuming and resource utilization intensive if used too frequently.

In the above it is implied that CLI command set auto-discovery 100 constitutes functionality available to the CLI script template management tool 200. The CLI command set auto-discovery 100 is not intended to be limited to CLI script template creation/modification. In accordance with another exemplary implementation of the exemplary embodiment of the invention, the NMS 102 may query 208 the network management repository 124 for active managed entities 104 deployed in the managed communications network having vendor, equipment type, and software version specifications for which an up-to-date CLI command dictionary 122 is not available in the network management repository 124. CLI command set auto-discovery 100 can be executed as a background process, preferably during off-peak hours or during configuration windows, to provide update CLI command dictionaries 122.

Parser 117 functionality besides the identification of CLI command tokens includes the identification of command parameters.

The CLI command syntax provided via the invocation 112 of the help functionality may also provide a listing of valid parameter values. Depending on the sophistication of the parser 117, the parser 117 may parse 118 the list in the output 114 and update 120 the CLI command dictionary 122 with the valid parameter values, otherwise the string corresponding to the list of parameter values may be stored.

In accordance with the exemplary embodiment of the invention, in order to enhance the analyst's productivity in creating/modifying CLI script templates, a CLI script template editor hot key sequence is assigned for invoking 212 command completion, to provide the same feel as if the analyst were actually interacting with an active managed entity 104. The key sequence unifies the different vendor specific character sequences used in invoking 112 help functionality on respective managed entities 114.

While editing a CLI script template, invoking 212 the command completion hot key of the CLI script template editor 200, the active CLI command dictionary 122 is accessed to retrieve learned CLI command specifications based on CLI command script template text in the vicinity of the cursor to provide 214 vendor specific, equipment type specific, and software version specific command completion functionality. Command completion functionality is, without limiting the invention, provided 214 via a pop-up window 216 with command completion options. FIG. 3 shows, cascaded pop-up windows 216 resulting from an exemplary successive invocation 212 of the CLI command completion hot key.

In accordance with the exemplary embodiment of the invention, an existing CLI script or an existing CLI script template may be validated for use on a target managed entity 104. Having specified a target managed entity 104, the availability of an up-to-date vendor specific, equipment specific, and software version specific CLI command dictionary 122 is checked by logging into the target managed entity 108, obtaining (110) the currently installed CLI command set, and querying 208 the network management repository 124 for a CLI command dictionary 122 corresponding to the vendor specific, equipment type specific CLI command set version employed by the managed entity 104. The parser 117 is used to step through the CLI script (template), parse 118 CLI command tokens; the CLI command token names and the sequence of CLI command tokes being checked against the CLI command set specification held in the CLI command dictionary 122. Discrepancies are highlighted for display to the analyst/operations management personnel. FIG. 4 shows such an exemplary CLI script (template) validation process. It is pointed out that in accordance with the exemplary embodiment of the invention, should a corresponding vendor specific, equipment-type specific, CLI command set version specific CLI command dictionary 122 not be found in the network management repository 124, the CLI command set auto-discovery process 100 is employed to obtain a CLI command dictionary 122 against which the subject CLI script (template) is validated.

In accordance with the exemplary embodiment of the invention, an analyst may retrieve a pair of CLI command dictionaries 122 having different software versions for a vendor specific, and equipment type specific managed entity, and request the identification of differences between the two CLI command dictionaries. The differences may be highlighted while being displayed to the analyst.

In accordance with the exemplary embodiment of the invention, a search of the network management repository 124 may be performed to identify CLI command dictionaries 122 having software versions no longer executed by any vendor specific and equipment type specific managed entity (104) deployed in the managed communications network. CLI command dictionaries no longer used, may be archived, thereby providing automated CLI command dictionary cleanup functionality.

Accordingly, the solution proposed herein addresses the above mentioned shortcomings of the prior art by providing CLI command set auto-discovery and CLI command completion, so that virtually any managed entity deployed in a managed communications network can be fully supported with ease despite the lack of CLI command commonality between vendor equipment, equipment types and even between software releases of the same vendor.

The embodiments presented are exemplary only and persons skilled in the art would appreciate that variations to the above described embodiments may be made without departing from the spirit of the invention. The scope of the invention is solely defined by the appended claims.

We claim:

1. A method of retrieving, in a network management and service provisioning context, a Command Line Interface (CLI) command set currently employed by a managed entity deployed in a managed communications network, the method comprising:
a. accessing the managed entity;
b. invoking help functionality on the managed entity;
c. capturing output generated by the managed entity in response to the invocation of the help functionality;
d. parsing the captured output; and
e. updating a CLI command dictionary based on the captured output.

2. The method claimed in claim 1, wherein accessing the managed entity further comprises selecting the managed entity from a plurality of managed entities deployed in the communications network.

3. The method claimed in claim 2, wherein selecting the managed entity further comprises interacting with a network map.

4. The method claimed in claim 1, wherein accessing the managed entity further comprises obtaining login information and logging into the managed entity.

5. The method claimed in claim 4, wherein obtaining login information further comprises querying a network management repository.

6. The method claimed in claim 4, wherein accessing the managed entity further comprises determining the CLI command set version employed by the managed entity from a successful login confirmation.

7. The method claimed in claim 6, wherein updating the CLI command dictionary further comprises updating a CLI command dictionary bearing the CLI command set version reported by the managed entity via the successful login confirmation.

8. The method claimed in claim 7, wherein the CLI command dictionary is maintained by a network management repository, the method further comprising querying the network management repository for a CLI command set version specific CLI command dictionary.

9. The method claimed in claim 8, updating the CLI command dictionary further comprising instantiating the CLI command set version specific CLI command dictionary if the network management repository query returns a negative response.

10. The method claimed in claim 1, wherein invoking the help functionality the method further comprises obtaining a character sequence invoking help functionality at the managed entity.

11. The method claimed in claim 1, wherein invoking the help functionality the method further comprises invoking contextual help functionality.

12. The method claimed in claim 11, the method further comprising successively invoking context specific help functionality based on previously captured output.

13. The method claimed in claim 1, wherein parsing the captured output the method further comprises determining one of a CLI command name, a configuration context specifier, and a CLI command syntax.

14. The method claimed in claim 13, wherein determining the CLI command syntax, the method further comprises determining one of a CLI command token, a CLI command parameter, and a valid CLI command parameter value specification.

15. The method claimed in claim 1, further comprising storing the CLI command dictionary in a network management repository.

16. A method of auto-completing a CLI command, in a network management and service provisioning context, based on a Command Line Interface (CLI) command set currently employed by target managed entity deployed in a managed communications network, the method comprising:
a. specifying the CLI command set version associated with the target managed entity;
b. optionally specifying at least one first character of a CLI command name;
c. invoking a command completion hot key;
d. querying a run-time loaded CLI command dictionary; and
e. providing a command completion options.

17. The method claimed in claim 16, further comprising a step of selecting the managed entity from a plurality of managed entities deployed in the communications network.

18. The method claimed in claim 17, wherein selecting the managed entity further comprises interacting with a network map.

19. The method claimed in claim 17, wherein specifying the CLI command set version associated with the target managed entity further comprises:
a. accessing the managed entity; and
b. determining the current CLI command set version deployed on the managed entity.

20. The method claimed in claim 19, wherein accessing the managed entity further comprises determining the CLI command set version employed by the managed entity from a successful login confirmation.

21. The method claimed in claim 20, further comprises obtaining login information and logging into the managed entity.

22. The method claimed in claim 21, wherein obtaining login information further comprises querying a network management repository.

23. The method claimed in claim 16, further comprising specifying the command completion hot key.

24. The method claimed in claim 16, wherein invoking the command completion hot key further comprises:
a. requesting the CLI command set version specific CLI command dictionary from a network management repository;
b. selectively loading a CLI command set version specific CLI command dictionary if the CLI command dictionary is available at the network management repository;
c. selectively invoking the method of retrieving a CLI command set currently employed by the target managed entity claimed in claim 1, if the CLI command dictionary is not available at the network management repository and in the absence of any specified first CLI command name characters; and
d. selectively invoking the method of retrieving a CLI command specification currently employed by the target managed entity claimed in claim 1, if the CLI command dictionary is not available at the network management repository based on the at least one first CLI command name character.

25. A method for validating one of a Command Line Interface (CLI) script and a CLI script template for execution on a target managed entity deployed in a managed communications network, the method comprising:
a. obtaining the CLI command set version of the CLI command set currently deployed on the target managed entity;
b. if the CLI command set version of the CLI command 'set currently deployed on the target managed entity matches the CLI command set version specified in respect of the one of the CLI script and the CLI script template, querying a run-time loaded CLI command ser version specific CLI command dictionary based on CLI command tokens specified in the one of the CLI script and the CLI script template; and
c. selectively highlighting CLI command token discrepancies between the CLI command token sequence specified in the one of the CLI script and the CLI script template, and the CLI command dictionary.

26. The method claimed in claim 25, wherein obtaining the CLI command set version further comprises querying a network management repository for the CLI command set version of the target managed entity.

27. The method claimed in claim 25, wherein obtaining the CLI command set version further comprises querying the target managed entity.

28. The method claimed in claim 27, further comprising:
a. logging into the target managed entity;
b. receiving confirmation of a successful login; and
c. extracting CLI command set version information from the confirmation of the successful login.

29. The method claimed in claim 28, further comprising retrieving login information for the target managed entity from a network management repository.

30. The method claimed in claim 25, wherein querying a run-time loaded CLI command ser version specific CLI command dictionary further comprises:
a. requesting the CLI command ser version specific CLI command dictionary from a network management repository;
b. selectively loading the CLI command ser version specific CLI command dictionary if available at the network management repository; and
c. selectively invoking the method of retrieving a CLI command set currently employed by the target managed entity claimed in claim 1, if the CLI command dictionary is not available at the network management repository.

31. A Command Line Interface (CLI) script template management system comprising:
a. a network management repository holding managed entity information for a managed entity deployed in a managed communications network;
b. a network management system for accessing the managed entity, the network management system further comprising:
i. messaging means for exchanging messages with the managed entity;
ii. means for capturing managed entity output from received messages; and
iii. a parser determining the CLI command set version from a message issued by the managed entity signifying a successful login, the parser updating a CLI command set version specific CLI command dictionary held in the network management repository based on CLI command set specifications obtained from the managed entity output captured; and
c. a CLI script template management tool operable in the network management and serviced provisioning context facilitated by the network management system to provide command completion in editing a CLI script template based on the CLI command set currently employed by the managed entity.

32. The system claimed in claim 31, wherein the network management repository holds login information for accessing the managed entity and the network management system accesses the managed entity based on the login information.

33. The system claimed in claim 31, wherein the network management repository further comprises a character sequence for invoking help functionality at the managed entity.

34. The system claimed in claim 33, wherein the network management repository further comprises a character sequence for invoking contextual help functionality at the managed entity.

35. The system claimed in claim 31, further comprising selection means for selecting the managed entity from a plurality of managed entities deployed in the managed communications network.

36. The system claimed in claim 31, wherein the messaging means further comprises:
a. transmission means for sending messages to the managed entity; and
b. reception means for receiving messages from the managed entity.

37. The system claimed in claim 31, wherein the parser updates the CLI command dictionary in respect of a specific CLI command configuration context.

38. The system claimed in claim 31, wherein the a CLI script template management tool further comprises a command completion hot key for providing a group of command completion options based on CLI command specifications held in the CLI command dictionary.

39. A Command Line Interface (CLI) command script template management tool for use in a centralized network management and service provisioning context, the CLI command script template management tool comprising:
a. a user-interface for specifying a vendor specific, equipment type specific, CLI command set version;
b. means for receiving user input in writing a CLI script template;
c. means for loading a vendor specific, equipment type specific, CLI command set version CLI command dictionary at run-time; and
d. a command completion hot key optionally responsive to at least one typed character to query the run-time loaded CLI command dictionary for command completion options.

40. The CLI script template management tool claimed in claim 39, the user-interface being used for one of selecting and specifying a target managed entity on which a CLI command set having the CLI command set version is deployed.

41. The CLI script template management tool claimed in claim 39, in the absence of any typed character, the CLI command dictionary loading means further comprises a trigger selectively invoking the method of retrieving a CLI command set currently employed by the target managed entity claimed in claim 1, if the CLI command dictionary is not available at a network management repository.

42. The CLI script template management tool claimed in claim 39, in the presence of at least one typed character, the CLI command dictionary loading means further comprises a trigger selectively invoking the method of retrieving a CLI command specification currently employed by the target managed entity claimed in claim 1, if the CLI command dictionary is not available at a network management repository based on the at least one character.

43. The CLI script template management tool claimed in claim 39, further comprising one of a CLI command script template editor and a CLI command script editor.

44. The CLI script template management tool claimed in claim 39, further comprising a pop-up window operable to provided the user with command completion options and command completion option selection means.
